(19) United States
(12) Patent Application Publication
(10) Pub. No.: US 2006/0061954 A1
(43) Pub. Date: Mar. 23, 2006

(54) Magnetic disk drive holder

(75) Inventor: Tai-Seng Lam, Taipei City (TW)

Correspondence Address: QUINE INTELLECTUAL PROPERTY LAW GROUP, P.C., P O BOX 458, ALAMEDA, CA, 94501, US

(73) Assignee: Flytech Technology Co., Ltd.

(21) Appl. No.: 10/943,598

(22) Filed: Sep. 17, 2004

(51) Int. Cl. G06F 1/16

(52) U.S. Cl. 361/685

(57) ABSTRACT

A magnetic disk drive holder is to be mounted within a computer case, and includes a main body, a carrier, and at least two elastic members. The main body is connected to the case and defines an opening. At least two supports are provided respectively on two opposing sides of the opening. The carrier is disposed in the opening, and includes at least two connectors which are provided respectively on two opposite sides of the carrier adjacent the opposing sides of the opening. Each of the elastic members has a first end connected to a respective one of the supports, and a second end connected to a respective one of the connectors.

### BACKGROUND OF THE INVENTION

1. Field of the Invention

The present invention relates to a magnetic disk drive holder. More particularly, the present invention relates to a magnetic disk drive holder to be mounted within a case of a personal computer, and that is capable of absorbing shock.

2. Description of the Related Art

Referring to FIG. 1, a typical desktop computer includes a case, such as a PC tower 111, and a monitor and peripherals (not shown) connected to the PC tower 111. A motherboard 12 is mounted in the PC tower 111, as are a plurality of bays 112 for holding magnetic disk drives 13, such as a hard disk drive, a floppy disk drive, a CD-RW, and an optical disk drive.

In the conventional method of mounting the magnetic disk drives 13 in the bays 112, screws 15 are used to secure the magnetic disk drives 13 directly to the bays 112. The bays 112, in turn, are connected directly to the PC tower 111 using screws or a lever mechanism that allows the bays 112 to be removed from the PC tower 111 when released.

As a result of this connection to the PC tower 111 through the bays 112, the magnetic disk drives 13 receive substantially the full force of any shock applied to the PC tower 111, such as when the PC tower 111 is struck against an object when moving the personal computer. If the shock is significant, the magnetic disk drives 13 are likely to be damaged.

### SUMMARY OF THE INVENTION

Therefore, the object of the present invention is to provide a magnetic disk drive holder for mounting within a computer case, and that is capable of absorbing shock to thereby provide protection to a magnetic disk drive mounted in the magnetic disk driver holder.

According to the present invention, a magnetic disk drive holder is to be mounted within a computer case and includes a main body adapted to be connected to the computer case. The main body defines an opening, and includes at least two supports which are provided respectively on two opposing sides of the opening. A carrier is disposed in the opening, and includes at least two connectors which are provided respectively on two opposite sides of the carrier, and adjacent the opposing sides of the opening.

The magnetic disk drive holder further includes at least two elastic members, each having a first end and a second end. The first end of each of the elastic members is connected to a respective one of the supports. The second end of each of the elastic members is connected to a respective one of the connectors. Each of the supports is spaced apart from a corresponding one of the connectors.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional PC tower shown with one side of the tower removed;

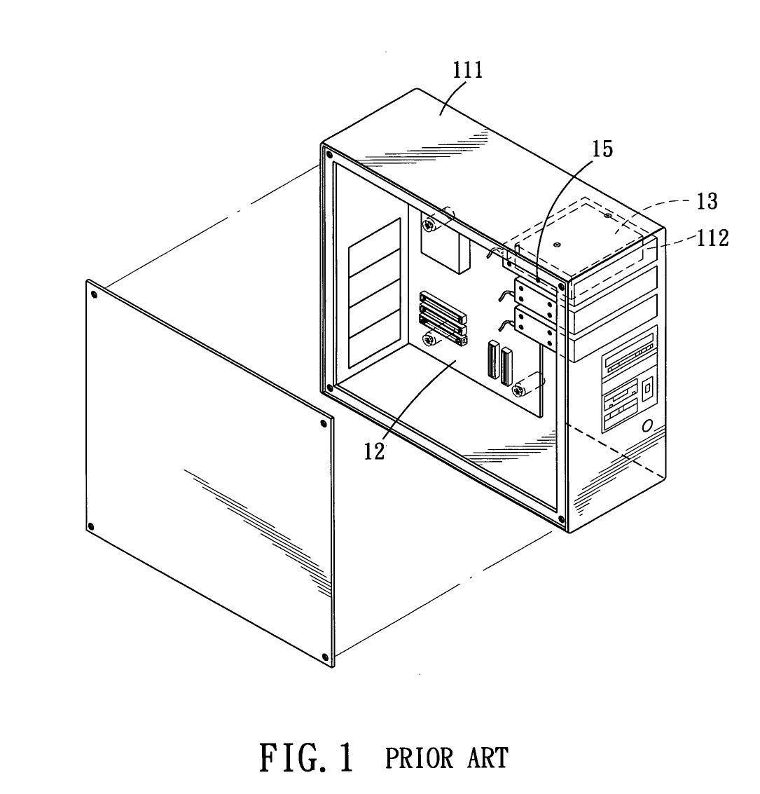

FIG. 2 is a fragmentary perspective view of a magnetic disk drive holder according to a preferred embodiment of the present invention shown in a state mounted in a PC case;

FIG. 3 is an exploded perspective view of the preferred embodiment;

FIG. 4 is a fragmentary perspective view of a magnetic disk drive holder according to a second preferred embodiment of the present invention shown in a state mounted in a PC case;

FIG. 5 is a fragmentary perspective view of a magnetic disk drive holder according to a third preferred embodiment of the present invention shown in a state mounted in a PC case;

FIG. 6 is a fragmentary perspective view of a magnetic disk drive holder according to a fourth preferred embodiment of the present invention shown in a state mounted in a PC case; and

FIG. 7 is a fragmentary perspective view of a magnetic disk drive holder according to a fifth preferred embodiment of the present invention shown in a state mounted in a PC case.

### DETAILED DESCRIPTION OF THE PREFERRED EMBODIMENTS

Before the present invention is described in greater detail, it should be noted that like elements are denoted by the same reference numerals throughout the disclosure.

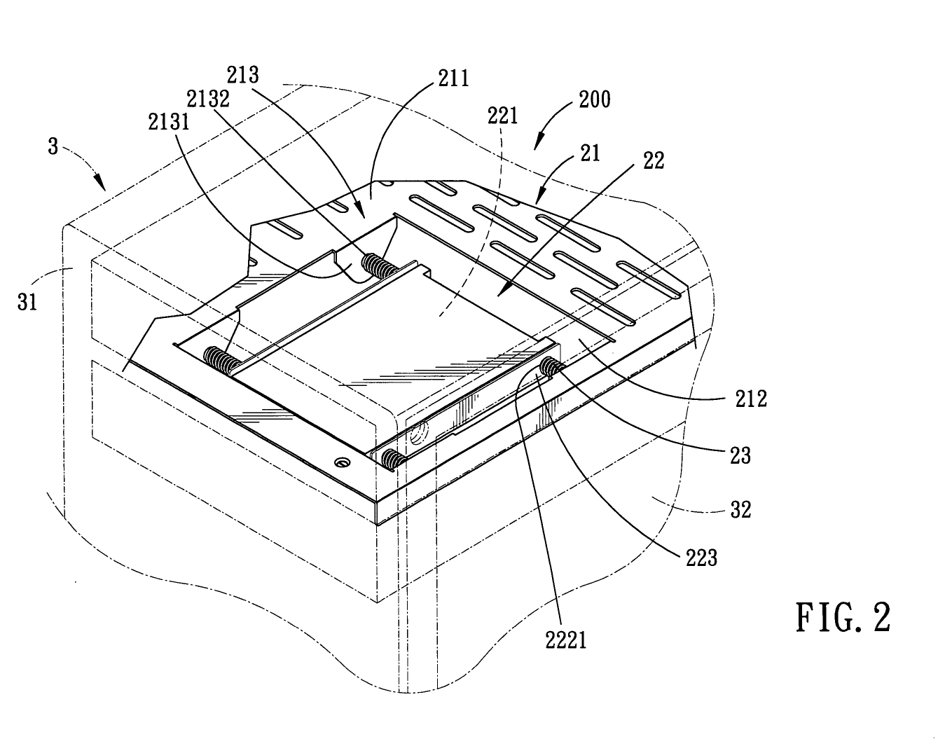

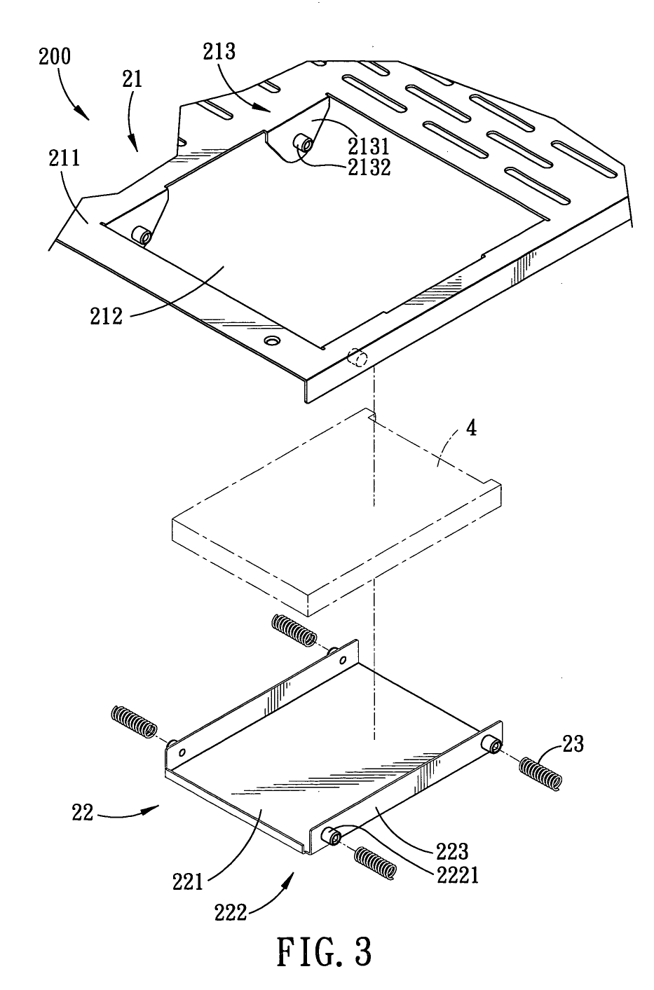

Referring to FIGS. 2 and 3, a magnetic disk drive holder 200 according to a first preferred embodiment is mounted in a case 3 of a personal computer. The case 3 includes a housing member 31, and a cover 32 removably mounted to the housing member 31. The magnetic disk drive holder 200 includes a main body 21, a carrier 22, and at least two elastic members 23.

The main body 21 includes a base plate 211, and an opening 212 that is formed through the base plate 211. In the first preferred embodiment, the base plate 211 includes an edge that confines the opening 212, which is substantially rectangular in shape, and at least one pair of supports 213 is provided respectively on two opposing sides of the opening 212. Each of the supports 213 includes a tab 2131 projecting from the edge, and a first protuberance 2132 extending from the tab 2131 into the opening 212.

The carrier 22 includes a bottom plate 221, and two sidewalls 223 respectively projecting from two opposite sides of the bottom plate 221 adjacent to the opposing sides of the opening 212 on which the supports 213 are provided. The sidewalls 223 extend between the tabs 2131 of the supports 213 that are adjacent to the sidewalls 223. The carrier 22 further includes at least two connectors 222 which are provided respectively on the sidewalls 223. In the first preferred embodiment, a pair of the connectors 222 is provided on each of the sidewalls 223. Each of the connectors 222 has a second protuberance 2221 which projects from one of the sidewalls 223. When the carrier 22 is positioned within the opening 212 of the main body 21, the supports 213 are spaced apart from a corresponding one of the connectors 222.

Each of the elastic members 23 is interposed between one of the supports 213 of the base plate 211, and an opposing respective one of the connectors 222 of the carrier 22. In the first preferred embodiment, each of the elastic members 23 is a coil spring having a first end connected to a respective one of the supports 213, and a second end connected to a respective one of the connectors 222. That is, the first end of each of the elastic members 23 is sleeved onto the first protuberance 2132 of the respective one of the supports 213, whereas the second end of each of the elastic members 23 is sleeved onto the second protuberance 2221 of the respective one of the connectors 222.

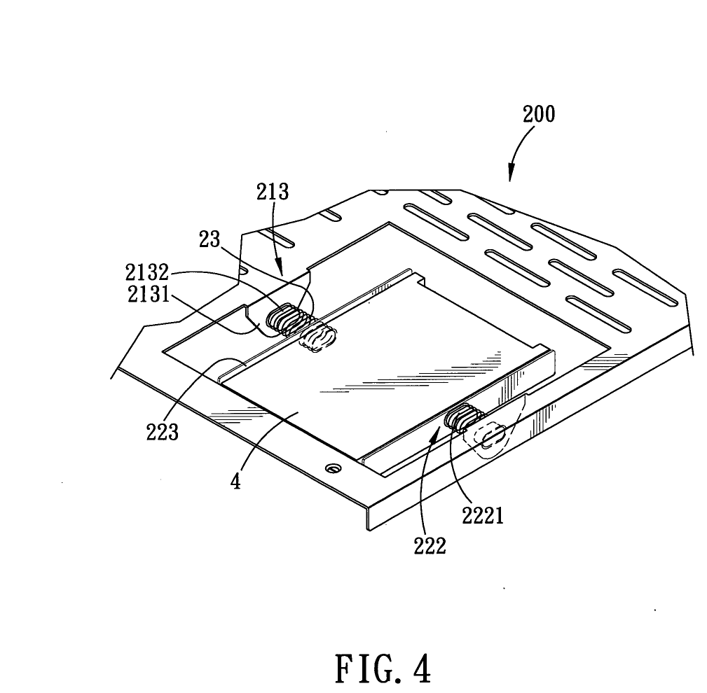

In a second preferred embodiment, with reference to FIG. 4, the supports 213 are provided respectively on two opposing sides of the opening 212, and at approximately a center location of each of the opposing sides. Preferably, the first protuberances 2132 that extend from the tabs 2131 of the supports 213 are made to a larger size than in the first preferred embodiment. Each of the second protuberances 2221 of the connectors 222 is formed at locations corresponding to a respective one of the first protuberances 2132 of the supports 213, and is similarly formed to a larger size. The elastic members 23 are sized to enable tight securing to the first and second protuberances 2132, 2221 when sleeved thereon.

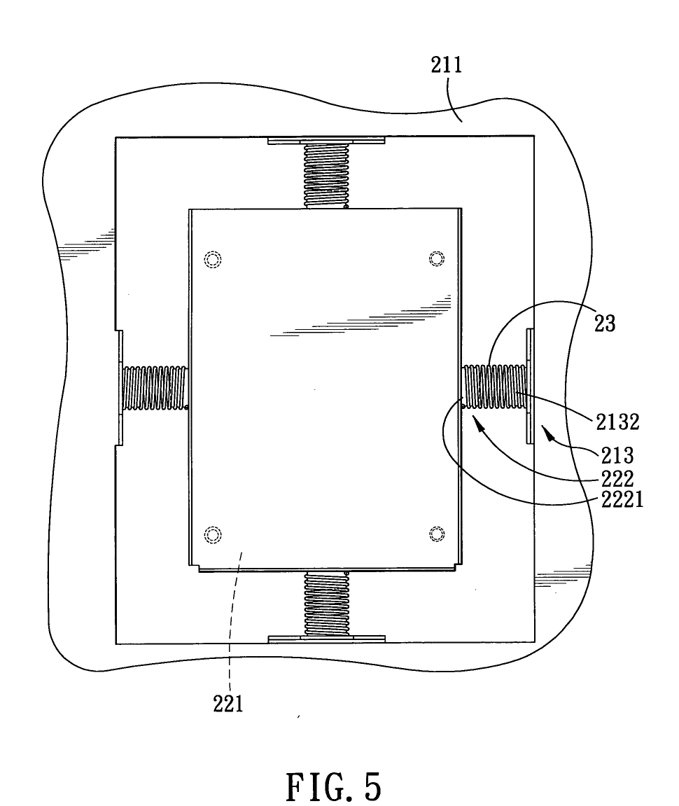

In a third preferred embodiment, with reference to FIG. 5, the supports 213 are provided respectively on each of the sides of the opening 212 at approximately center locations thereof. Each of the second protuberances 2221 of the connectors 222 is formed at locations corresponding to a respective one of the first protuberances 2132 of the supports 213. Sizes of the first protuberances 2132 of the supports 212, the second protuberances 2221 of the connectors 222, and the elastic members 23 may be adjusted as needed.

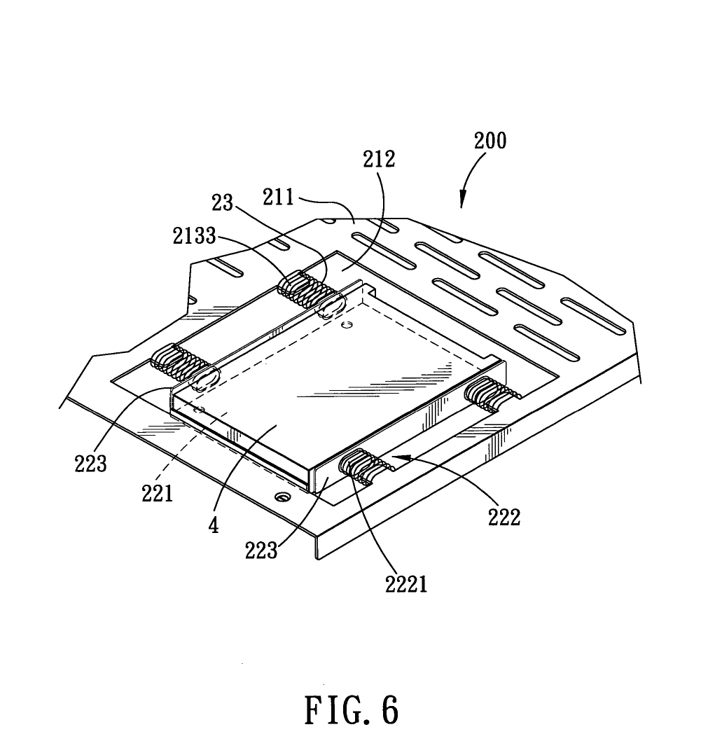

In a fourth preferred embodiment, with reference to FIG. 6, projections 2133 maybe formed extending directly from opposing sides of the opening 212 (i.e., from opposing sides of the edge confining the opening 212). This is in contrast to being provided on the tabs 2131 as in the preceding embodiments. All other aspects of the fourth preferred embodiment are identical to those of the preceding embodiments.

To better secure the elastic members 23 to the main body 21 and the carrier 22, each or a selected number of the first protuberances 2132, the projections 2133, and the second protuberances 2221 may include an engaging member (not shown) for holding one end of a respective one of the elastic members 23.

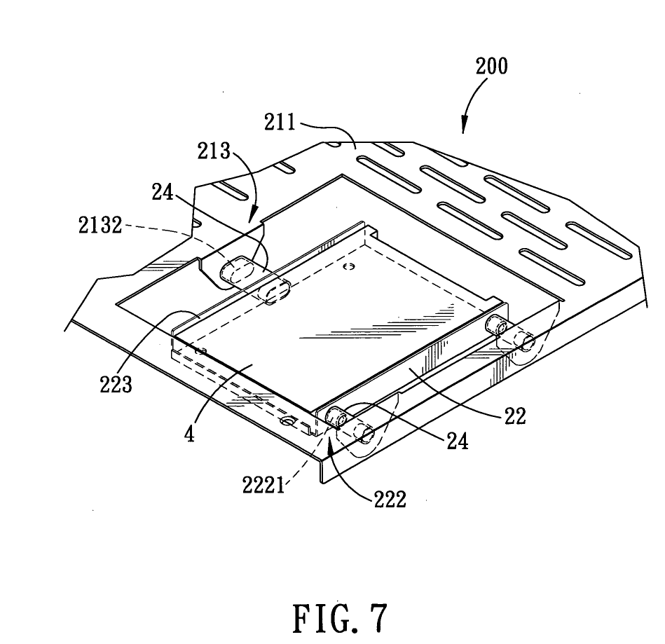

In a fifth preferred embodiment, referring to FIG. 7, the elastic members may be formed as rubber tubes 24 with first and second ends. Each of the first ends of the rubber tubes 24 is sleeved on a corresponding one of the first protuberances 2132 of the supports 213. Each of the second ends of the rubber tubes 24 is sleeved on a corresponding one of the second protuberances 2221 of the connectors 222.

Using the first preferred embodiment as an example, assembly of the magnetic disk drive holder 200 will now be described. The main body 21 is mounted in the housing member 31 of the case 3, and a magnetic disk drive 4 is mounted on the bottom plate 221 of the carrier 22. As an example of the mounting of the magnetic disk drive 4 to the carrier 22, the bottom plate 221 and/or the sidewalls 223 of the carrier 22, as well as the magnetic disk drive 4 may be formed with a plurality of screw holes (not shown) to allow for the magnetic disk drive 4 tone secured to the carrier 22 using screws (not shown)

Next, each of the first ends of the elastic members 23 is sleeved onto the first protuberance 2132 of a respective one of the supports 213. The carrier 22 with the magnetic disk drive 4 mounted thereon is then positioned in the opening 212 of the main body 21, and the second end of each elastic member 23 is sleeved onto the second protuberance 2221 of a respective one of the connectors 222.

Alternatively, the carrier 22 with the magnetic disk drive 4 mounted thereon may first be mounted to the main body 21 through interconnection using the elastic members 23 as described above. Next, this completed assembly of the magnetic disk drive holder 200 may be mounted in the housing member 31 of the case 3.

In view of the foregoing construction, when the case 3 receives an external shock, such as when the case 3 is inadvertently struck against another object when moving the same, the carrier 22 moves within the opening 212 of the main body 21 by deformation of the elastic members 23. Movement of the carrier 22 occurs in rapid succession in roughly opposite directions by such deformation action of the elastic members 23 until the energy of this force dissipates. Hence, the force is distributed over a period of time by the elastic members 23, and therefore is far less destructive than if the carrier 22 was rigidly connected to the main body 21. The end result is that the magnetic disk drive 4 mounted on the carrier 22 is prevented from receiving large external shocks that may be inadvertently applied to the case 3, thereby protecting the magnetic disk drive 4 from damage.

Further, the magnetic disk drive holder 200 according to the preferred embodiments is simple in structure, and utilizes common, widely available materials for its constituent elements. Therefore, manufacturing costs are low, and assembly and mounting operations are simple.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A magnetic disk drive holder for mounting within a computer case, comprising:
a main body adapted to be connected to the computer case and defining an opening, said main body including at least two supports which are provided respectively on two opposing sides of said opening;
a carrier disposed in said opening, said carrier including at least two connectors which are provided respectively on two opposite sides of said carrier and adjacent said opposing sides of said opening; and
at least two elastic members each having a first end and a second end, said first end of each of said elastic members being connected to a respective one of said supports, said second end of each of said elastic members being connected to a respective one of said connectors, each of said supports being spaced apart from a corresponding one of said connectors.

2. The magnetic disk drive holder as claimed in claim 1, wherein said main body is formed as a base plate, said opening being formed in said base plate, said base plate including an edge confining said opening, each of said supports having a tab projecting from said edge and a first protuberance extending from said tab into said opening and connected to said first end of one of said elastic members.

3. The magnetic disk drive holder as claimed in claim 2, wherein said carrier includes a bottom plate and two sidewalls respectively projecting from two opposite sides of said bottom plate, each of said connectors having a second protuberance which projects from one of said sidewalls and which is connected to said second end of one of said elastic members.

4. The magnetic disk drive holder as claimed in claim 3, wherein each of said elastic members is formed as a coil spring, said first end being sleeved onto said first protuberance, said second end being sleeved onto said second protuberance, said coil spring bridging said first and second protuberances.

5. The magnetic disk drive holder as claimed in claim 4, wherein said opening is rectangular, said main body having two pairs of said supports, said carrier having two pairs of said connectors, said bottom plate of said carrier being rectangular.
